(19) United States
(12) Patent Application Publication
(10) Pub. No.: US 2008/0028620 A1
(43) Pub. Date: Feb. 7, 2008

(54) DETACHABLE COVER FOR A HAND-HELD POWER TOOL

(76) Inventor: Albrecht Kreissig, Stuttgart (DE)

Correspondence Address: MICHAEL J. STRIKER, 103 EAST NECK ROAD, HUNTINGTON, NY, 11743, US

(21) Appl. No.: 11/830,022

(22) Filed: Jul. 30, 2007

(30) Foreign Application Priority Data
Aug. 3, 2006 (DE) 102006036216.0
May 3, 2007 (DE) 102007020676.5

(51) Int. Cl. A01G 3/00; F16C 17/00

(52) U.S. Cl. 30/196; 384/15

(57) ABSTRACT

A detachable cover for a hand-held power tool has a sliding guide, a locking device configured to hold the cover in a closed position, and a handle, the handle being configured as a tilt-thrust element actable upon with a manual actuating force, the tilt-thrust element being tilted around a horizontal axis and forming an acute angle with a sliding direction of the sliding guide, which acute angle is located in front of a horizontal axis as viewed in a sliding-open direction.

### CROSS-REFERENCE TO A RELATED APPLICATION

The invention described and claimed hereinbelow is also described in German Patent Applications DE 102006036216.0 filed on Aug. 3, 2006 and 102007020676.5 filed on May 3, 2007. These German Patent Applications, whose subject matter is incorporated here by reference, provides the basis for a claim of priority of invention under 35 U.S.C. 119(a)-(d).

### BACKGROUND OF THE INVENTION

The present invention relates to a detachable cover for a hand-held power tool, particularly an electrical hand-held power tool, which includes a sliding guide and a locking device that holds the cover in a closed position, and which includes a handle.

Detachable covers of the type described initially are known. Publication DE 28 39 780 C2 discloses a cutting device with a mechanism for easily replacing its knife. The cutting device includes a cover, which holds the cutting tool on the cutting device. The cover includes two recesses, which correspond with two pegs in the housing of the cutting tool. In the attached state, the projections are guided through the recesses and the pegs are fixedly retained via a spring element that acts in a rear grip of the projections, thereby preventing the cover from becoming detached from the housing. To release the cover, the spring element must be bent manually in order to release the projections from the rear grip.

Furthermore, publication U.S. Pat. No. 3,959,878 describes electrical hedge trimmers, with which a cutting tool composed of two parts is detachably mounted on the rest of the hand-held power tool. The cutting tool is composed of a first part, which can make a motion relative to a second part, which is detachably mountable on the housing. The second part includes two recesses, into each of which a resilient spring element—that is designed as a single piece with the housing of the hand-held power tool—is engaged and snapped into place using a sliding motion. To release the fixed part, the spring elements must be pressed inwardly from two sides, thereby releasing the locked-in position and enabling the cutting tool to be removed.

An electrical power tool with a swivelable cover is also known that is unlocked using two small buttons located on the sides, and that is released via a sliding motion and is then rotated or swung open around a joint.

A cover that slides in a guide is also known that includes a snap-in button that must be lifted before opening. This must be done before the cover can be slid.

### SUMMARY OF THE INVENTION

According to the present invention, the handle is designed as a tilt-thrust element to be acted on with manual actuating force. When the tilt-thrust element is tilted around a horizontal axis, it forms an acute angle with the sliding direction of the sliding guide, which is located in front of the horizontal axis as viewed in the sliding-open direction.

A design of the cover of this type makes it particularly easy to release the cover from the hand-held power tool and/or the housing of the hand-held power tool, since, due to the inventive design of the tilted tilt-thrust element, the actuating direction of the tilt-thrust element and the sliding-open direction overlap. The tilt-thrust element can therefore be pressed with the thumb, for example, while the cover is simultaneously pushed or pulled in the sliding-open direction with the thumb. The user can therefore easily release the cover with one hand.

Advantageously, the tilt-thrust element includes at least one locking projection for engaging in a locking receptacle of the hand-held power tool, particularly in a locking receptacle of a housing of the hand-held power tool. Advantageously, in the non-tilted or non-actuated state of the tilt-thrust element, the locking projection engages in the locking receptacle, thereby preventing the cover from being displaced or released. When the tilt-thrust element is actuated, the lock is released by lifting or tilting the locking projection out of the locking receptacle. Advantageously, the locking projection on the tilt-thrust element is located—relative to the horizontal axis—on the side of the tilt-thrust element opposite to the side acted upon by the actuating force. When the tilt-thrust element is actuated, one side of the tilt-thrust element is therefore pressed downward, thereby causing the the locking projection to be lifted out of the locking receptacle on the other side of the horizontal axis.

According to a refinement of the present invention, the handle includes at least one spring element, thereby enabling the tilt-thrust element to return to a starting position after having been actuated; the starting position advantageously corresponds to the locked position of the handle of the locking element of the cover. For this purpose, the spring element is advantageously operatively connected with the tilt-thrust element and the cover. To close the cover, it is therefore sufficient to slide the cover in the sliding-closed direction in order to lock the cover on the hand-held power tool, in which case the locking projection is pressed into the locking receptable via the spring element.

Advantageously, the locking projection includes a starting bevel in the sliding-closed direction, thereby enabling the locking projection to be disengaged by an edge or a projection of the housing when the cover is slid in the sliding-closed direction, and preventing it from catching thereon.

Advantageously, the spring element is designed as a torsion bar. It simultaneously serves as the horizontal axis of the tilt-thrust element.

For this purpose, the spring element is advantageously designed as a single piece with the cover and/or the tilt-thrust element. As a result, it is possible to manufacture the cover with the locking device in a particularly favorable and simple manner. When the spring element is designed as a single piece with the cover and the tilt-thrust element, the cover is a single component, which simplifies handling for a user, and it simplifies manufacture. In addition, the spring properties of the torsion bar can therefore be realized in a simple and cost-favorable manner.

According to a refinement of the present invention, the handle is formed in the cover via a free punch. This means the tilt-thrust element and the spring element or torsion bar are stamped out of the cover. Advantageously, the entire handle is not stamped out, i.e., it is not separated from the cover, but rather remains partially connected with the cover. As a result, the torsion bar is formed as a single piece with the cover and the tilt-thrust element, and it can act in a resilient manner. The free punch can be created using a common separation process, e.g., milling, laser cutting, or punching.

According to a refinement of the present invention, the sliding guide of the cover includes at least one detachable sliding rear grip. This prevents the cover from becoming detached in one direction, perpendicularly to the sliding direction of the sliding guide. Advantageously, the sliding rear grip and/or the sliding guide are/is also designed as a single piece with the cover.

The cover is preferably made of plastic. This means that the cover is lightweight, and that the inventive cover can be manufactured simply and cost-favorably.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a cover in accordance with the present invention in a perspective top view of the top side,

FIG. 2 shows the cover in accordance with the present invention in a perspective top view of the underside,

FIG. 3 shows the cover in accordance with the present invention in a top view of the top side,

FIG. 4 shows the cover in accordance with the present invention in a side view,

FIG. 5 shows a sectional view of the cover in accordance with the present invention, and

FIG. 6 shows a portion of a hand-held power tool with the cover in accordance with the present invention.

### DESCRIPTION OF THE PREFERRED EMBODIMENTS

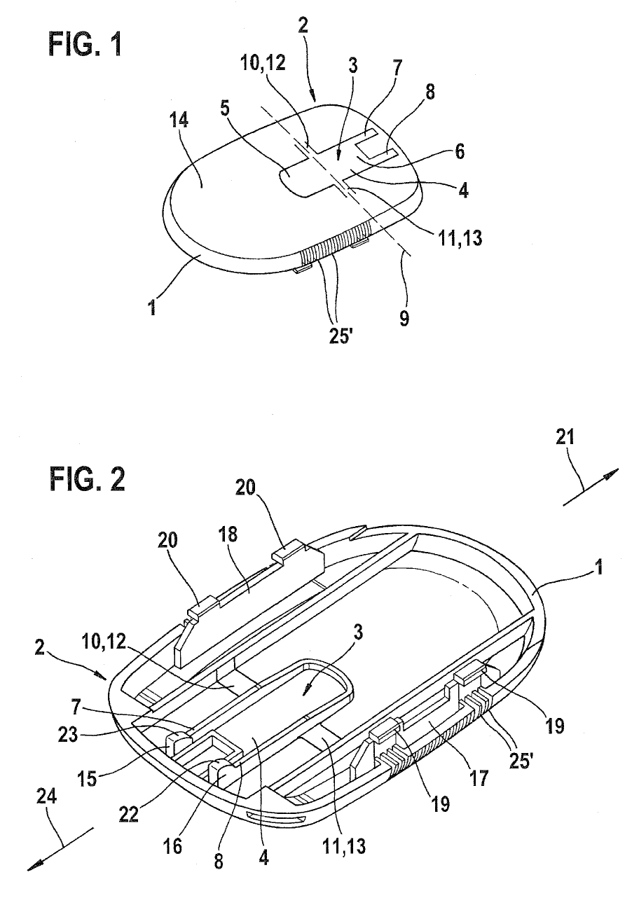

FIG. 1 shows a perspective view of a top view of the upper side of an inventive cover 1 capable of being installed on a hand-held power tool, particularly an electrical hand-held power tool. Cover 1 has an essentially oval contour, and the contours extend partially nearly parallel with each other on the longer sides. Cover 1 includes a handle 3 in an end region 2, which is designed as a single piece with cover 1. Handle 3 includes a tilt-thrust element 4, which includes an actuating region 5 pointing toward the middle of cover 1, and a locking region 6 pointing toward the edge of cover 1.

Locking region 6 includes a U-shaped end formed by two locking arms 7 and 8. Locking region 6 and actuating region 5 meet at a horizontal axis 9 formed by two torsion bars 10 and 11 that lie on a straight line in their longitudinal extension. Handle 3 is formed by the free punch in cover 1. Torsion bars 10 and 11 serve as spring elements 12 and 13; they are integrally formed with tilt-thrust element 4 and cover 1 at their ends. Thrust element 4, torsion bars 10 and 11 and the rest of the cover form a flat surface 14.

When tilt-thrust element 4 is actuated, i.e., when a compression force is exerted on actuating region 5 of tilt-thrust element 4, actuating region 5 is tilted downward and, as a result, locking region 6 of tilt-thrust element 4 is tilted upward around horizontal axis 9.

FIG. 2 shows cover 1 in FIG. 1; the same reference numerals are used here and in the remaining figures, in a perspective top view of the underside. Tilt-thrust element 4 of handle 3 includes locking projections 15 and 16 on the underside of locking arms 7 and 8, which engage in corresponding locking recesses of a hand-held power tool or a housing of hand-held power tool in the locked state. Sliding guides 17 and 18 are formed on the edge region of cover 1, parallel to the longitudinal extension of tilt-thrust element 4, i.e., perpendicularly to horizontal axis 9. Sliding guides 17 and 18 each include two sliding rear grips 19 and 20, which are oriented outwardly. Sliding guides 17 and 18 and, in particular, sliding rear grips 19 and 20 correspond with matching recesses in the housing of the not-shown hand-held power tool, so that sliding rear grips 19 and 20 latch behind the housing when cover is slid in sliding-closed direction 21, thereby securing cover 1 via a form-fit connection perpendicularly to sliding-closed direction 21.

Cover 1 rests on the housing via its edge region. When cover 1 is closed, locking projections 15 and 16 are also inserted into corresponding counter-receptacles of the housing via the spring force of spring elements 12 and 13 or torsion bars 10 and 11. To this end, locking projections 15 and 16 each include starting bevels 22, 23 in sliding-closed direction 21. During closing, therefore, projections 15 and 16 can be slid out, in accordance with the direction of actuation of tilt-thrust element 4, and they can then be pressed into the corresponding receptacles via the spring force of torsion bars 10 and 11. Locking projections 15 and 16 are therefore prevented from catching on the housing of the hand-held power tool. When tilt-thrust element 4 is actuated, as explained with reference to FIG. 1, tilt-thrust element 4 tilts around its horizontal axis 9, and projections 15 and 16 of locking arms 7 and 8 are lifted out of the locking receptacles of the housing, thereby enabling the cover to be slid in sliding-open direction 24 and enabling sliding rear grips 19 and 20 to be released.

The advantageous embodiment of cover 1, according to which the tilt-thrust element—when in the tilted state—forms an acute angle with the sliding direction of sliding guide 17, 18, the acute angle being located in front of horizontal axis 9, as shown in FIGS. 1 through 6—allows a user to unlock cover is 1, slide it in the sliding-open direction and therefore release it from the housing, all with one hand. Due to the single-piece design of handle 3 with cover 1, a particularly simple and cost-favorable mechanism for locking and unlocking of cover 1 on a housing is provided. Advantageously, sliding guides 17 and 18 and/or sliding rear grips 19 and 20 are formed as a single piece with cover 1.

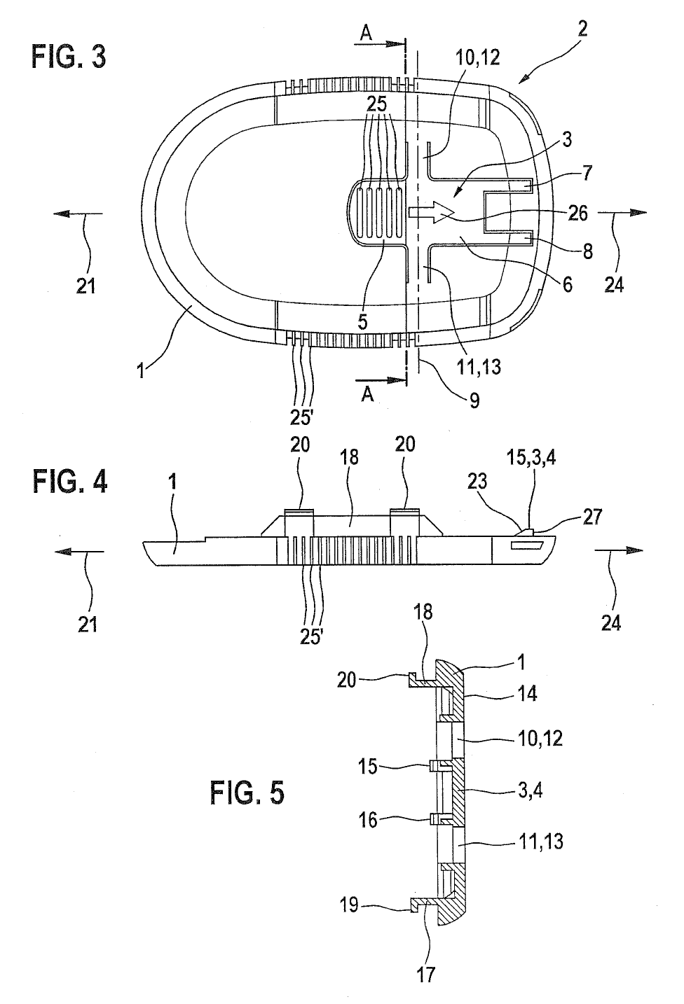

FIG. 3 shows a top view of cover 1. Handle 3 includes ridge-type recesses and/or raised areas 25 on actuating region 5, which are oriented perpendicularly to sliding-opening direction 24 or sliding-closed direction 21. Due to these ridge-type recesses and/or raised areas 25 on actuating region 5, a user is therefore able to apply a great deal of sliding force on handle 3 when actuating handle 3 and opening cover 1. The thumb is therefore largely prevented from sliding off when handle 3 is actuated, for example. Arrow 26 formed on the handle, e.g., via stamping, serves as a guide for the user and as easily understood instructions for using handle 3 of cover 1.

The advantageous embodiment of cover 1 allows a tool of the hand-held power tool retained or covered by cover 1 to be replaced quickly and easily, and a user need use only one hand to unlock and open cover 1.

FIG. 4 shows a side view of cover 1 in the previous figures. FIG. 4 clearly depicts how locking projection 15 of handle 3 shown here advantageously projects out of the cover, thereby enabling it to engage in a corresponding locking recess in a housing. Just as starting bevel 23 of tilt-thrust element 4 serves to move projection 15 outward when cover 1 is moved in sliding-closing direction 21, a straight edge surface 27 located on the opposite side and formed perpendicularly to the sliding direction serves to prevent locking projection 15 from accidentally being released from the locking receptacle, provided cover 1 is only moved in sliding-open direction 24. The same applies for locking projection 16, of course, which is not shown in this side view.

Recesses and/or raised areas 25′ are formed perpendicularly to the sliding direction on the longer sides of cover 1, and they also serve to improve and simplify the handling of the cover by the user.

FIG. 5 shows cover 1 in a sectional view along line A-A shown in FIG. 3. Line A-A extends through the open space formed by the free punch between torsion bars 10 and 11 and spring elements 12 and 13, each of which is formed as a single piece with cover 1 and handle 3, and with tilt-thrust element 4. Sliding rear grips 19 and 20 are also shown clearly in the sectional view. When rear grips 19 and 20 latch behind corresponding projections of the housing when cover 1 is displaced, cover 1 is secured via a form fit perpendicularly to the sliding direction.

Cover 1 is advantageously made of plastic, making it lightweight and easy and cost-favorable to manufacture. Of course, the plastic is selected such that torsion bars 10 and 11 and spring elements 12 and 13 have sufficient elasticity to return tilt-thrust element 4 to a starting position corresponding to the locked position when actuated by a user. In all of the figures, tilt-thrust element 4 of cover 1 is shown in its locked position.

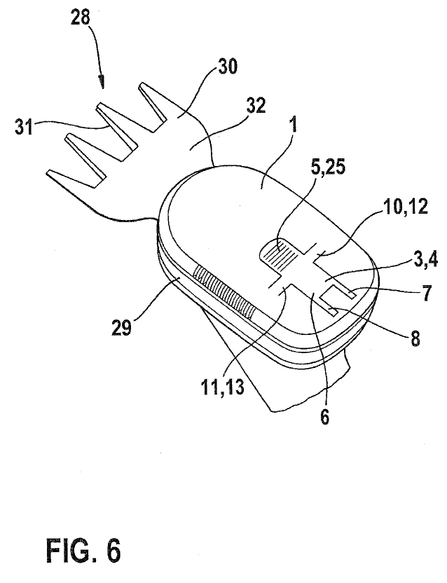

FIG. 6 shows a part of electrical power tool 28 in a perspective illustration. Electrical hand-held power tool 28 includes a housing 29, on which inventive cover 1 from the previous figures is located. Cover 1 is in the locked state on housing 29 of electrical hand-held power tool 28. Electrical hand-held power tool 28 is designed as a hand-held cutting power tool, e.g., for trimming hedges, and includes, for this purpose, a two-part cutting tool 30 that is supported in housing 29, is operatively connected with a transmission, and is held in position by cover 1.

Inventive cover 1 makes it possible to quickly and conveniently replace cutting tool 30, since the actuating direction for unlocking the cover and the sliding-open direction intersect, so that the user need only actuate handle 3 and exert force on actuating region 5 of tilt-thrust element 4 to unlock and displace cover 1 in the sliding-open direction.

Cutting tool 30 is operatively connected with a transmission in housing 29; the transmission drives a movable part 31 of a cutting tool 30, while a corresponding, fixed part 32 of cutting tool 30 rests on cover 1 and is thereby retained by it, thereby ensuring that entire cutting tool 30 is locked in place on electrical hand-held power tool 28.

It will be understood that each of the elements described above, or two or more together, may also find a useful application in other types of constructions differing from the type described above.

While the invention has been illustrated and described as embodied in a detachable cover for a hand-held power tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A detachable cover for a hand-held power tool, comprising a sliding guide; a locking device configured to hold the cover in a closed position; and a handle, said handle being configured as a tilt-thrust element actable upon with a manual actuating force, said tilt-thrust element being tilted around a horizontal axis and forming an acute angle with a sliding direction of said sliding guide, which acute angle is located in front of a horizontal axis as viewed in a sliding-open direction.

2. A detachable cover as defined in claim 1, wherein said tilt-thrust element includes at least one locking projection engageable in a locking receptacle of a housing of the hand-held power tool.

3. A detachable cover as defined in claim 2, wherein said locking projection is configured for engaging in the locking receptacle of a housing of the hand-held power tool.

4. A detachable cover as defined in claim 1, wherein said handle includes at least one spring element.

5. A detachable cover as defined in claim 4, wherein said spring element is operatively connected with said tilt-thrust element and the cover.

6. A detachable cover as defined in claim 2, wherein said locking projection includes at least one starting bevel in a sliding-closed direction.

7. A detachable cover as defined in claim 4, wherein said spring element of said handle is configured as a torsion bar.

8. A detachable cover as defined in claim 4, wherein said spring element of said handle is configured as a single piece with a part selected from the group consisting of the cover, said tilt-thrust element, and both.

9. A detachable cover as defined in claim 1, wherein said handle is formed as a freely punched part of the cover.

10. A detachable cover as defined in claim 1, wherein said sliding guide includes at least one detachable sliding rear grip.

11. A detachable cover as defined in claim 1, wherein the cover is composed of plastic.

12. A hand-held power tool, comprising a cover including a sliding guide, a locking device configured to hold the cover in a closed position, and a handle, said handle being configured as a tilt-thrust element actable upon with a manual actuating force, said tilt-thrust element being tilted around a horizontal axis and forming an acute angle with a sliding direction of said sliding guide, which acute angle is located in front of a horizontal axis as viewed in a sliding-open direction.

13. A hand-held power tool as defined in claim 12, wherein the hand-held power tool is an electrical hand-held power tool.

14. A detachable cover for a hand-held power tool, comprising a sliding guide; a locking device configured to hold the cover in a closed position; and a handle, said handle being configured as a tilt-thrust element actable upon with a manual actuating force, said tilt-thrust element, for removing the cover, being configured to tilt around a horizontal axis and to be guided along the sliding guide.
